(19) United States
(12) Patent Application Publication
(10) Pub. No.: US 2017/0079860 A1
(43) Pub. Date: Mar. 23, 2017

(54) Self-Contained Ambulance Equipment Module

(71) Applicant: John E. McLoughlin, Hauppauge, NY (US)

(72) Inventor: John E. McLoughlin, Hauppauge, NY (US)

(21) Appl. No.: 15/215,581

(22) Filed: Jul. 20, 2016

Related U.S. Application Data
(60) Provisional application No. 62/221,572, filed on Sep. 21, 2015.

(51) Int. Cl. A61G 3/00; B60R 16/033; B60H 1/00; B60R 16/03

(52) U.S. Cl. CPC A61G 3/00; B60R 16/03; B60R 16/033; B60H 1/00; A61G 3/008; B60R 16/0307

(57) ABSTRACT

A self-contained ambulance equipment module comprises an undercarriage, a module body constructed of a sturdy material mounted on top of the undercarriage, the body housing a plurality of ambulance equipment, and a quick disconnect coupler attached to the module body and configured to couple to a vehicle.

### RELATED APPLICATION

This patent application claims the benefit of U.S. Provisional Patent Application Ser. No. 62/221572 filed on Sep. 21, 2015 and entitled “Self-Contained Ambulance Equipment Module.”

### FIELD

This disclosure relates to ambulance vehicles, and more particularly to a self-contained ambulance equipment module configured for quick interface and coupling with a vehicle.

### BACKGROUND

An ambulance is a vehicle used to transport sick or injured people to and from medical facilities. Ambulances are typically equipped with warning lights, sirens, and lifesaving equipment, such as oxygen, high flow CPAP, automated external defibrillator (AED), stretcher, etc. The price tag for these ambulance vehicles typically costs about $150,000 unequipped, with an additional $100,000 worth of medical equipment needed to outfit the ambulance.

### DESCRIPTION OF THE DRAWINGS

FIG. 1 is a side view of an exemplary embodiment of a self-contained ambulance equipment module being carried on a flatbed truck according to the teachings of the present disclosure;

FIG. 2 is a side view of an exemplary embodiment of a self-contained ambulance equipment module being hitched by a vehicle according to the teachings of the present disclosure;

FIG. 3 is a side view of an exemplary embodiment of a self-contained ambulance equipment module being carried on a pick-up truck according to the teachings of the present disclosure;

FIG. 4 is a simplified block diagram of an exemplary embodiment of a self-contained ambulance equipment module according to the teachings of the present disclosure; and

FIG. 5 is a perspective view of an exemplary embodiment of the interior of the self-contained ambulance equipment module according to the teachings of the present disclosure.

### DETAILED DESCRIPTION

The self-contained ambulance equipment module is a solution primarily directed at the need to transport patients with highly contagious and deadly diseases, such as ebola, small pox, etc. After transporting these patients, the patient-care surfaces inside an ambulance and all medical equipment have to be carefully and thoroughly cleaned and decontaminated. This may take an ambulance out of service for a prolonged period of time. The inventive concept herein involves using a plurality of self-contained ambulance equipment modules that may be quickly installed, loaded, or hitched to a vehicle (truck cab, flatbed truck, van, pick-up truck, etc.) for service, and quickly taken out of service by removing the attachment to the vehicle for cleaning and disinfection. Meanwhile, the vehicle may be quickly hitched or otherwise coupled to a clean ambulance module to service the next patient. This modular approach permits a more rapid response to contagious disease outbreaks.

FIG. 1 is a side view of an exemplary embodiment of a self-contained ambulance equipment module 10 being carried on a flatbed truck 12 according to the teachings of the present disclosure. The self-contained ambulance equipment module 10 is constructed and sized to be securely carried on the flat level bed 14 of a truck 12 or another type of vehicle. The module 10 may be securely fastened to the flatbed 14 using a number of types of fasteners that may be custom-made for this purpose. For example, clips, clamps, ropes, chains, and other means may be used. Unlike conventional ambulances, the self-contained ambulance equipment module 10 is designed for quick connect and disconnect coupling with the flatbed truck 12. An electrical cable harness and connectors (not explicitly shown) may be used to quickly enable connecting and disconnecting of the electrical system (including the battery) of the truck 12 to the equipment module 10 to provide power and control coupling therebetween. Using a crane/wench or another mechanism, the self-contained module 10 may be lifted onto the flatbed and secured thereto, and decommissioned for cleaning and disinfecting by removing the module 10 from the flatbed truck 12, thus quickly freeing the truck to be put back into commission by reloading it with a clean module.

The module body framework is typically made of formed or extruded aluminum. The outer walls may be painted aluminum sheet, and the interior walls are usually aluminum sheet covered with a vinyl coating or a laminated plastic. The subfloor may be made of plywood or may use an open-cored plastic honey-comb laminated to aluminum sheet. The interior floor covering is usually a seamless, industrial-grade vinyl that extends partially up each side for easy cleaning. The module 10 includes rear-access doors, one or more window openings, brake lights, reflective strips, and scene/warning lighting. The module is electrically-connected to the truck cab so that its battery may be used to power the warning lights, siren, climate control equipment (e.g., air conditioning, heater, HEPA air filtration), and medical equipment in the module 10. The module 10 may further include its own batteries and/or power generator for this purpose. The module 10 may include a battery that is configured to store electrical power generated by the engine of the vehicle, for example. Further, controls for the lights and other functions may be located in the truck cab.

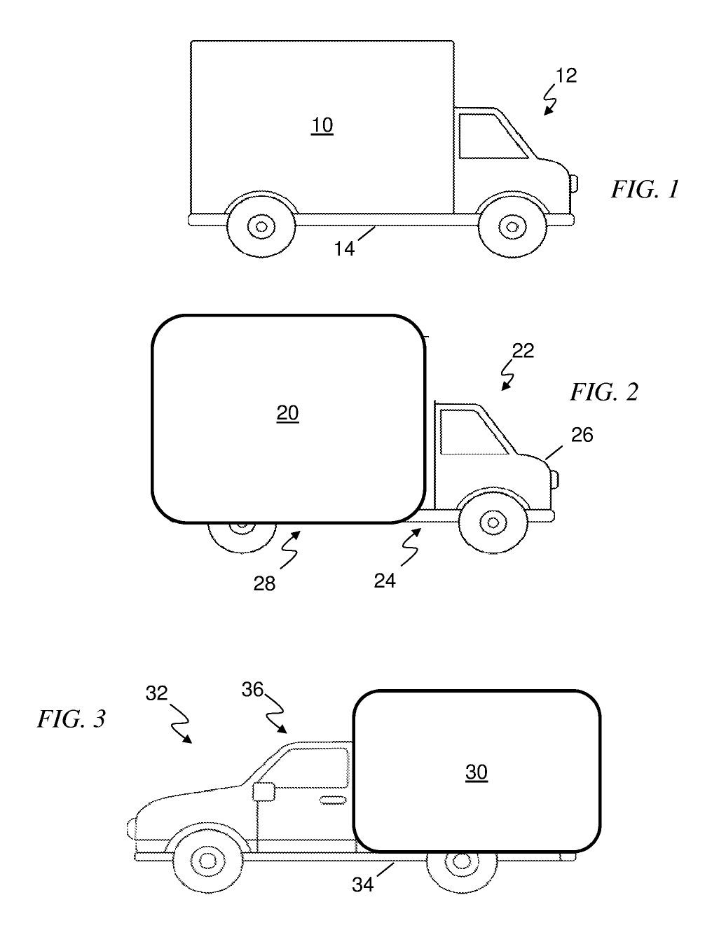

FIG. 2 is a side view of an exemplary embodiment of a self-contained ambulance equipment module 20 being hitched to a vehicle 22 according to the teachings of the present disclosure. The body framework of the self-contained ambulance equipment module 20 in this instance is more rigid that can withstand more lateral forces. The self-contained module 20 is equipped much like the embodiment depicted in FIG. 1 as described above, but further comprises a hitch 24 to be secured to the truck cab 26 and an under carriage 28 that includes a plurality of tires. The vehicle 22 also includes the engine, drivetrain, and all of the mechanical components that enable the vehicle to move and carry the load. An electrical cable harness and connectors (not explicitly shown) may be used to quickly enable connecting and disconnecting of the electrical system (including the battery) of the truck 22 to the equipment module 20 to provide power and control coupling therebetween. The module 20 may include a battery that is configured to store electrical power generated by the engine of the vehicle, for example. In this embodiment, the self-contained ambulance equipment module 20 may be put into service by hitching it to a tow ball or another form of coupler mounted on a truck cab 26. The electrical cable harness may be integrated and incorporated with the hitching mechanism so that coupling of the module to the vehicle may be done quickly and easily. After transporting a patient, the self-contained module 20 may be quickly decoupled from the truck cab 26 to be thoroughly cleaned and disinfected while the truck cab 26 can be quickly pressed into service by hitching it to a clean module.

FIG. 3 is a side view of an exemplary embodiment of a self-contained ambulance equipment module 30 being hitched to a vehicle 32 according to the teachings of the present disclosure. The self-contained ambulance equipment module 30 is constructed and sized to be securely carried on the bed of a modified pickup truck 32. The module 30 may be securely fastened to the flatbed 34 using a number of types of fasteners that may be custom-made for this purpose. The self-contained module 30 is equipped much like the embodiment depicted in FIGS. 1 and 2 as described above. An electrical cable harness and connectors (not explicitly shown) may be used to quickly enable connecting and disconnecting of the electrical system (including the battery) of the truck 32 to the equipment module 30 to provide power and control coupling therebetween. The module may include a battery that is configured to store electrical power generated by the engine of the vehicle, for example. The pickup truck may require slight modification to enable a custom fit of the equipment module 30 onto the bed 34 of the pickup truck 32. After transporting a patient, the self-contained module 30 may be quickly decoupled from the truck cab 36 to be thoroughly cleaned and disinfected while the truck cab 36 can be quickly pressed into service by loading and securing a clean decontaminated module onto the pickup truck bed.

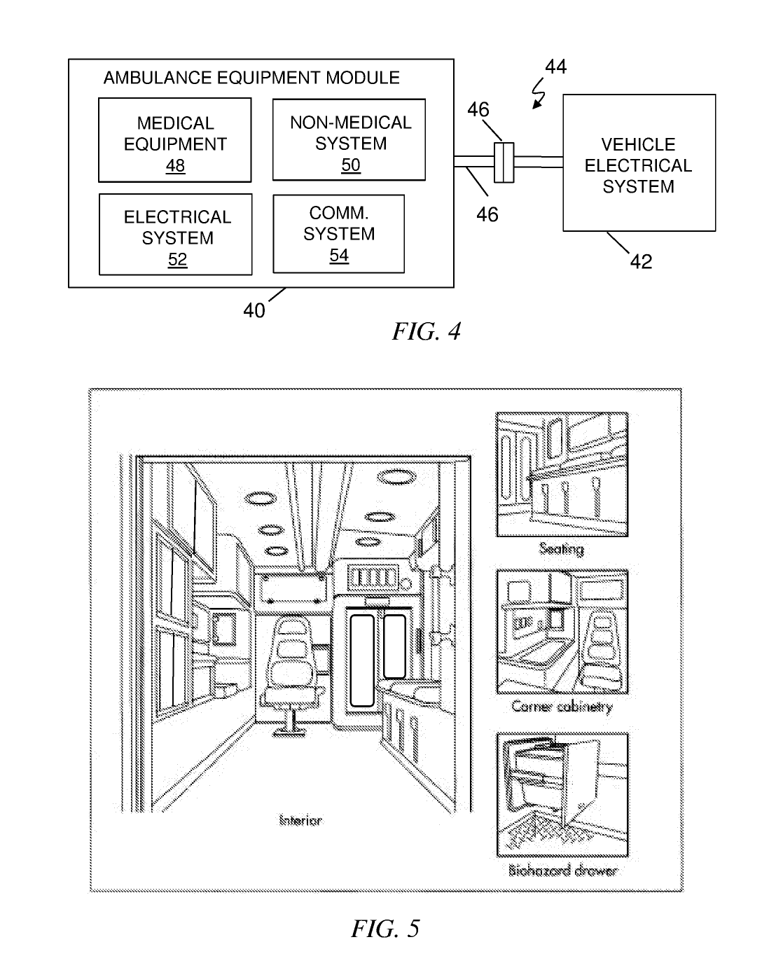

FIG. 4 is a simplified block diagram of an exemplary embodiment of the self-contained ambulance equipment module according to the teachings of the present disclosure. The self-contained ambulance equipment module 40 is coupled to the electrical system 42 of the vehicle using a quick-connect interface 44. An electrical harness comprising one or more electrical cables 46 may be used to transmit electrical power and control data from the vehicle to the module 40. A quick-release connector 46 may be used to couple the cables to enable a seamless electrical connection. The ambulance equipment module 40 includes medical equipment 48 (e.g., life support equipment), non-medical equipment 50 (e.g., lights, climate-control system, air filtration system, etc.), electrical system 52, and communication system 54 (e.g., wireless or wired communication). Wireless communication system may employ any appropriate communication channel and protocol such as WiFi, cellular, mobile satellite, etc. The communication system 54 enables personnel inside the module to communicate with dispatch, hospital emergency room, physicians, and other personnel. In embodiments where the ambulance equipment module includes its own power supply in the form of batteries and/or a generator, the harness cables may carry, for example, on/off control data to control the equipment onboard the module, communication data to enable interaction and communication between personnel in the cab and the module, and other signals.

FIG. 5 is a perspective view of an exemplary embodiment of the interior of the self-contained ambulance equipment module according to the teachings of the present disclosure. The self-contained ambulance equipment module is preferably equipped much like a typical ambulance, with basic life support (BLS) or advanced life support (ALS) equipment to stabilize the patient's condition while en route (e.g., cardiac monitor and defibrillator, oropharyngeal airways, nasopharayngeal airways, self-inflating bag-valve mask devices, masks for bag-valve-mask device, oxygen masks, non-breather masks, nasal cannulas, portable and mounted oxygen supply, portable and mounted suction, suction catheters, stethoscopes, laryngoscope with blades, endotracheal tube stylets, endotracheal tubes, CO2 detection devices, intubation kits, bulb syringe, blood pressure cuffs, thermometers, etc.). Typical equipment may include blood pressure cuff, oxygen, glucometer, high flow CPAP, automated external defibrillator (AED), echocardiogram (EKG), suction equipment, stretcher, and cabinets that house drugs, IV fluid, personal protective equipment (PPE) including disposable gloves, goggles, face mask, gowns, shoe covers, and other medical supplies. Some of the equipment may be wall-mounted to the walls of the equipment module, while other equipment and supplies may be stored in built-in cabinets, drawers, and closets inside the equipment module. Built-in lockable storage compartments and units are temperature-regulated to ensure proper storage for medicines, drugs, and supplies. The storage compartments are preferably sealed when closed to keep out contaminants. Some of the supplies (PPE etc.) may instead be stored in the front cab of the vehicle to avoid contamination. A biohazard disposal unit or bin may also be installed in the module to contain used supplies. A HEPA filtration system and a system that keeps the module interior at a negative air pressure are also desirable. Other features may include ample interior lighting, electrical outlets, one or more swivel padded seats with seatbelts for the EMT crew, one or more window openings, and wireless communication equipment (audio only or video) with the cab as well as hospital emergency department. All equipment and supplies are securely fastened or contained in storage so that they are not disturbed by movement of the truck while in transit. The equipment module interior is arranged to easily accommodate a stretcher carrying a patient.

Interior cabinets in the patient compartment are usually made of non-porous, and easy to clean materials such as aluminum with plastic panels in the doors. The counter and wall surfaces in the “action area,” the area immediately opposite the patient's head and torso in the left-hand forward portion of the ambulance body, are usually covered with a seamless sheet of stainless steel or similar material to resist the effects of blood and other body fluids. Interior seating and other upholstered areas have a flame-retardant foam padding with a vinyl covering. Interior grab handles and grab rails are made of stainless steel. Other interior trim pieces may be made of various rubber or plastic materials. Equipment and other interior surfaces may be specially coated to facilitate cleaning and decontamination.

The self-contained ambulance equipment module is preferably designed and constructed to meet existing applicable standards for ambulances published by, for example, the General Services Administration (GSA) and The National Fire Protection Association (NFPA).

A typical ambulance is based on either the chassis of a van or truck. In the US, there are four types of ambulances. There are Type I, Type II, Type III and Type IV. Type I is based upon a heavy truck chassis and is used primarily for Advanced Life Support and rescue work. Type II is a van based ambulance with little modifications except for a raised roof. Its use is for basic life support and transfer of patients. The Type III is a van chassis but with a custom made rear compartment and has the same use as Type I ambulances. Type IV's are nomenclature for smaller ad hoc patient transfer using smaller utility vehicles where passenger vehicles and trucks would have difficulty in traversing, such as large industrial complexes, commercial venues, and special events with large crowds. The inventive concept herein contemplates hitching or otherwise coupling the self-contained ambulance equipment module to generic truck, van, pickup truck, or other vehicles that may be modified, specially-constructed, or custom-made for this purpose.

The features of the present invention which are believed to be novel are set forth below with particularity in the appended claims. However, modifications, variations, and changes to the exemplary embodiments described above will be apparent to those skilled in the art, and the self-contained ambulance equipment module described herein thus encompasses such modifications, variations, and changes and are not limited to the specific embodiments described herein.

What is claimed is:

1. A self-contained ambulance equipment module comprising:
an undercarriage having a plurality of tires;
a module body constructed of a sturdy material mounted on top of the undercarriage, the module body housing a plurality of ambulance medical equipment and supplies configured for life supporting functions;
an electrical harness having a quick disconnect electrical coupler configured to couple to an electrical system of a vehicle; and
a hitch configured to couple to a tow coupler of the vehicle so that the vehicle may tow and pull the self-contained ambulance equipment module.

2. The self-contained ambulance equipment module of claim 1, wherein the electrical harness comprises at least one power cable configured to receive electrical power from the vehicle to power the plurality of ambulance medical equipment.

3. The self-contained ambulance equipment module of claim 1, further comprising at least one battery configured to store and provide electrical power to power the plurality of ambulance medical equipment.

4. The self-contained ambulance equipment module of claim 1, further comprising an electrical generator configured to provide electrical power to power the plurality of ambulance medical equipment.

5. The self-contained ambulance equipment module of claim 1, further comprising a climate control system configured to regulate temperatures in the module body.

6. The self-contained ambulance equipment module of claim 1, further comprising a storage compartment that is climate controlled to store medical supplies at the proper temperature.

7. The self-contained ambulance equipment module of claim 1, further comprising storage compartments configured for storing basic life support equipment in the module body.

8. The self-contained ambulance equipment module of claim 1 further comprising storage compartments configured for storing advanced life support equipment in the module body.

9. The self-contained ambulance equipment module of claim 1, wherein the electrical harness comprises at least one data cable configured to transmit control signals from the vehicle to control the plurality of ambulance medical equipment.

10. The self-contained ambulance equipment module of claim 1, further comprising non-medical equipment and wherein the electrical harness comprises at least one data cable configured to transmit control signals from the vehicle to control the non-medical equipment.

11. The self-contained ambulance equipment module of claim 1, further comprising communication equipment and wherein the electrical harness comprises at least one data cable configured to transmit communication signals between the vehicle and the module body.

12. The self-contained ambulance equipment module of claim 1, further comprising wireless communication equipment configured to enable personnel inside the module body to communicate with personnel in the vehicle.

13. The self-contained ambulance equipment module of claim 1, further comprising wireless communication equipment configured to enable personnel inside the module body to communicate with outside world.

14. A self-contained ambulance equipment module comprising:
a module body constructed of a sturdy material configured for mounting on a load-carrying bed of a vehicle, the module body housing a plurality of ambulance medical equipment and supplies configured for life supporting functions;
a plurality of fasteners configured to secure the module body to the vehicle;
an electrical harness having a quick disconnect electrical coupler configured to couple to an electrical system of a vehicle; and
wherein the module body may be separated from the load-carrying bed of the vehicle by disconnecting the electrical coupler, unfastening the plurality of fasteners, and removing the module body from the load-carrying bed.

15. The self-contained ambulance equipment module of claim 14, wherein the electrical harness comprises at least one power cable configured to receive electrical power from the vehicle to power the plurality of ambulance medical equipment.

16. The self-contained ambulance equipment module of claim 14, further comprising at least one battery configured to store and provide electrical power to power the plurality of ambulance medical equipment.

17. The self-contained ambulance equipment module of claim 14, further comprising an electrical generator configured to provide electrical power to power the plurality of ambulance medical equipment.

18. The self-contained ambulance equipment module of claim 14, further comprising a climate control system configured to regulate temperatures in the module body.

19. The self-contained ambulance equipment module of claim 14, further comprising a storage compartment that is climate controlled to store medical supplies at the proper temperature.

20. The self-contained ambulance equipment module of claim 14, further comprising storage compartments configured for storing basic life support equipment in the module body.

21. The self-contained ambulance equipment module of claim 14, further comprising storage compartments configured for storing advanced life support equipment in the module body.

22. The self-contained ambulance equipment module of claim 14, wherein the electrical harness comprises at least one data cable configured to transmit control signals from the vehicle to control the plurality of ambulance medical equipment.

23. The self-contained ambulance equipment module of claim 14, further comprising non-medical equipment and wherein the electrical harness comprises at least one data cable configured to transmit control signals from the vehicle to control the non-medical equipment.

24. The self-contained ambulance equipment module of claim 14, further comprising communication equipment and wherein the electrical harness comprises at least one data cable configured to transmit communication signals between the vehicle and the module body.

25. The self-contained ambulance equipment module of claim 14, further comprising wireless communication equipment configured to enable personnel inside the module body to communicate with personnel in the vehicle.

26. The self-contained ambulance equipment module of claim 14, further comprising wireless communication equipment configured to enable personnel inside the module body to communicate with outside world.

27. A self-contained ambulance equipment module comprising:
a module body constructed of a sturdy material configured for mounting on a load-carrying bed of a vehicle, the module body housing a plurality of ambulance medical equipment and supplies configured for life supporting functions;
a power supply;
an electrical harness having a quick disconnect electrical coupler configured to couple to an electrical system of a vehicle; and
wherein the module body may be separated from the load-carrying bed of the vehicle by disconnecting the electrical coupler, and removing the module body from the load-carrying bed.
